(19) United States
(12) Patent Application Publication
(10) Pub. No.: US 2007/0057907 A1
(43) Pub. Date: Mar. 15, 2007

(54) Display device, drive device, and drive method

(75) Inventors: Junichiro Ishii, Matsumoto-shi (JP); Shintaro Nagasaki, Azumino-shi (JP)

Correspondence Address: GLOBAL IP COUNSELORS, LLP, 1233 20TH STREET, NW, SUITE 700, WASHINGTON, DC, 20036-2680, US

(73) Assignee: Seiko Epson Corporation, Shinjuku-ku (JP)

(21) Appl. No.: 11/512,242

(22) Filed: Aug. 30, 2006

(30) Foreign Application Priority Data
Sep. 14, 2005 (JP) JP 2005-267543

(51) Int. Cl. G09G 3/34

(52) U.S. Cl. 345/107

(57) ABSTRACT

A display device comprising an electrophoretic display panel comprising two types of electrophoretic particles of different color and polarity between electrodes, and a drive unit for supplying a drive signal to apply a drive voltage between the electrodes to switch a display color of the electrophoretic display panel between the colors of the electrophoretic particles. The drive unit supplies a drive signal of which the drive power is changed according to the electrophoretic characteristics when the display color of the electrophoretic display panel is changed in order to change the display color of the electrophoretic display panel.

### BACKGROUND

1. Field of Technology

The present invention relates to technology for avoiding uneven display of colors on an electrophoretic display panel.

2. Description of Related Art

Display devices comprising an electrophoretic display panel that operate using electrophoresis, a phenomenon whereby charged particles dispersed in a fluid migrate when an electric field is applied, are known from the literature. This type of electrophoretic display panel has an electrophoretic layer filled with black and white electrophoretic particles, for example, disposed between electrodes. When a drive voltage with a positive or negative potential is applied between the electrodes, either the black or the white electrophoretic particles migrate to the display surface side of the electrophoretic layer so that the color displayed at the display surface is white or black (see, for example, Japanese Unexamined Patent Appl. Pub. S52-70791). Migration of the electrophoretic particles also becomes slower when a drive voltage is applied after the display state of this type of electrophoretic display panel has not changed for a long time (see, for example, Japanese Unexamined Patent Appl. Pub. S51-41992).

In a two-particle electrophoretic display panel having black and white particles, for example, if one display area A displays white (so that the white particles are on the display surface side of the electrophoretic layer and the black particles migrate to the opposite side as the display surface side) for ten minutes, the adjacent display area B is then switched to also display white, and then both display areas A and B are switched to display black, the black displayed in display area A will be slightly whitish compared with the black in display area B because the electrophoretic characteristics of this electrophoretic display panel change when there is no change in the displayed content for a long time, and colors displayed in adjacent display areas will differ slightly (in achievable reflectivity and contrast).

We discovered that if the display area to be switched to a different color is large when changing the content displayed on an electrophoretic display panel, the color will not change sufficiently even though the same drive voltage is applied, that is, the electrophoretic characteristics change according to the size of the display area in which the color is being changed. As a result, if the display color is changed in different size areas, the achievable reflectivity will be lower in the larger area, and inconsistent colors result.

### SUMMARY OF THE INVENTION

An object of the present invention is therefore to provide a display device that can avoid displaying inconsistent colors resulting from the electrophoretic characteristics of the display areas when the display is switched, and to provide a drive device and a drive method for driving this electrophoretic display panel.

A display device according to a first aspect of the invention comprises an electrophoretic display panel having two types of electrophoretic particles of different color and polarity between electrodes, and a drive unit for supplying a drive signal to apply a drive voltage between the electrodes and switching a display color of the electrophoretic display panel between the colors of the electrophoretic particles. The drive unit supplies a drive signal of which the drive power is changed according to the electrophoretic characteristics when the display color of the electrophoretic display panel is changed.

By supplying a drive signal of which the drive power varies according to the electrophoretic characteristics of the display when the display is redrawn in order to change the display color of the electrophoretic display panel, changes in the electrophoretic characteristics can be corrected when changing the display color, and an inconsistent color display caused by differences in electrophoretic characteristics when redrawing the display can be avoided.

Preferably, the drive unit supplies a drive signal of which the drive power is changed according to the continuous display time of the display color before the display color changes when the display color of the electrophoretic display panel is changed. Further preferably, the drive unit supplies a drive signal in which the number of drive pulses for applying the drive voltage is changed according to the continuous display time of the display color before the display color changes, or supplies a drive signal in which the drive voltage apply time is changed according to the continuous display time of the display color before the display color changes, or supplies a drive signal in which the drive voltage is changed according to the continuous display time of the display color before the display color changes.

An inconsistent color display caused by differences in electrophoretic characteristics that change according to how long a color has been continuously displayed before the display is redrawn can be avoided.

In another aspect of the invention the drive unit supplies a drive signal of which the drive power is changed according to the area of the display color being changed when the display color of the electrophoretic display panel is changed. Further preferably, the drive unit supplies a drive signal in which the number of drive pulses for applying the drive voltage is changed according to the area of the display color being changed when the display color of the electrophoretic display panel is changed, or supplies a drive signal in which the drive voltage apply time is changed according to the area of the display color being changed when the display color of the electrophoretic display panel is changed, or supplies a drive signal in which the drive voltage is changed according to the area of the display color being changed when the display color of the electrophoretic display panel is changed.

An inconsistent color display caused by differences in electrophoretic characteristics that change according to the size of the area of the display color being changed when the display is redrawn can be avoided.

A drive device according to another aspect of the invention comprises a drive unit for supplying a drive signal to apply a drive voltage between electrodes of an electrophoretic display panel comprising two types of electrophoretic particles of different color and polarity between the electrodes. The drive unit supplies a drive signal of which the drive power is changed according to the electrophoretic characteristics when the display color of the electrophoretic display panel is changed.

By supplying a drive signal of which the drive power varies according to the electrophoretic characteristics of the display when the display is redrawn in order to change the display color of the electrophoretic display panel, changes in the electrophoretic characteristics can be corrected when changing the display color, and an inconsistent color display caused by differences in electrophoretic characteristics when redrawing the display can be avoided.

Preferably, the drive unit supplies a drive signal of which the drive power is changed according to the continuous display time of the display color before the display color changes when the display color of the electrophoretic display panel is changed. Further preferably, the drive unit supplies a drive signal in which the number of drive pulses for applying the drive voltage is changed according to the continuous display time of the display color before the display color changes, or supplies a drive signal in which the drive voltage apply time is changed according to the continuous display time of the display color before the display color changes, or supplies a drive signal in which the drive voltage is changed according to the continuous display time of the display color before the display color changes.

An inconsistent color display caused by differences in electrophoretic characteristics that change according to how long a color has been continuously displayed before the display is redrawn can be avoided.

In a drive device according to another aspect of the invention, the drive unit supplies a drive signal of which the drive power is changed according to the area of the display color being changed when the display color of the electrophoretic display panel is changed. Yet further preferably, the drive unit supplies a drive signal in which the number of drive pulses for applying the drive voltage is changed according to the area of the display color being changed when the display color of the electrophoretic display panel is changed, or supplies a drive signal in which the drive voltage apply time is changed according to the area of the display color being changed when the display color of the electrophoretic display panel is changed, or supplies a drive signal in which the drive voltage is changed according to the area of the display color being changed when the display color of the electrophoretic display panel is changed.

An inconsistent color display caused by differences in electrophoretic characteristics that change according to the size of the area of the display color being changed when the display is redrawn can be avoided.

Another aspect of the invention is a drive method for supplying a drive signal to apply a drive voltage between electrodes of an electrophoretic display panel comprising two types of electrophoretic particles of different color and polarity between the electrodes to change a display color of the electrophoretic display panel between the colors of the electrophoretic particles, wherein a drive signal of which the drive power is changed according to the electrophoretic characteristics when the display color of the electrophoretic display panel is changed is supplied when changing the display color of the electrophoretic display panel.

By supplying a drive signal of which the drive power varies according to the electrophoretic characteristics of the display when the display is redrawn in order to change the display color of the electrophoretic display panel, changes in the electrophoretic characteristics can be corrected when changing the display color, and an inconsistent color display caused by differences in electrophoretic characteristics when redrawing the display can be avoided.

Preferably, this drive method supplies a drive signal of which the drive power is changed according to the continuous display time of the display color before the display color changes when changing the display color of the electrophoretic display panel. Further preferably, the drive method supplies a drive signal in which the number of drive pulses for applying the drive voltage is changed according to the continuous display time of the display color before the display color changes, or supplies a drive signal in which the drive voltage apply time is changed according to the continuous display time of the display color before the display color changes, or supplies a drive signal in which the drive voltage is changed according to the continuous display time of the display color before the display color changes.

An inconsistent color display caused by differences in electrophoretic characteristics that change according to how long a color has been continuously displayed before the display is redrawn can be avoided.

In another aspect of the invention the drive method supplies a drive signal of which the drive power is changed according to the area of the display color being changed when the display color of the electrophoretic display panel is changed. Further preferably, the drive unit supplies a drive signal in which the number of drive pulses for applying the drive voltage is changed according to the area of the display color being changed when the display color of the electrophoretic display panel is changed, or supplies a drive signal in which the drive voltage apply time is changed according to the area of the display color being changed when the display color of the electrophoretic display panel is changed, or supplies a drive signal in which the drive voltage is changed according to the area of the display color being changed when the display color of the electrophoretic display panel is changed.

An inconsistent color display caused by differences in electrophoretic characteristics that change according to the size of the area of the display color being changed when the display is redrawn can be avoided.

### BRIEF DESCRIPTION OF THE DRAWINGS

FIG. 1 is a plan view of a wristwatch according to a preferred embodiment of the invention.

FIG. 2 describes the display panel of this wristwatch.

FIG. 3 is a schematic section view of the time display unit in the wristwatch.

FIG. 4 is a section view showing the arrangement of the display panel.

FIG. 5 is a block diagram showing the electrical arrangement of the time display unit.

FIG. 6 is a table showing display density levels.

FIG. 7 describes the drive signal waveform applied to the display panel.

FIG. 8 is a flow chart of the drawing process.

FIG. 9 is a flow chart of the display refreshing process and the current level update process.

FIG. 10 is a flow chart of the drawing process in a wristwatch according to a second embodiment of the invention.

### DESCRIPTION OF THE PREFERRED EMBODIMENTS

A preferred embodiment of the present invention is described below with reference to the accompanying figures.

### First Embodiment

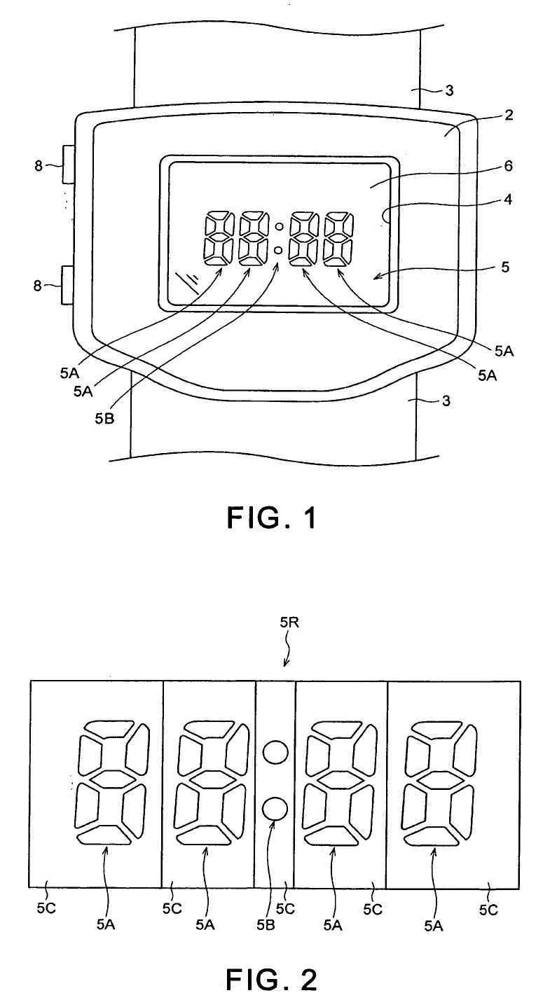

FIG. 1 shows the appearance of a wristwatch 1 according to this embodiment of the invention. As shown in the figure, the wristwatch 1 has a watch case 2, and a wrist band 3 that is attached to the watch case 2 and used to hold the wristwatch 1 on the user's wrist. A time display window 4 for displaying the time is formed in the front of the watch case 2 so that the display panel 5 that displays the time, for example, can be seen through the time display window 4. A crystal 6 made from transparent plastic or transparent glass, for example, is fit into the time display window 4, and the display panel 5 is protected by this crystal 6. Operating buttons 8 for setting the time, changing the operating mode, and performing other operations are also disposed to the watch case 2.

The display panel 5 is a segment display panel for displaying information using a plurality of segments. As shown in FIG. 2, the display area 5R of this display panel 5 comprises four segments (so-called “seven-segment displays”) 5A for displaying the numbers 0 to 9. The left two segments 5A display the hour of the time, and the right two segments 5A display the minute. A segment 5B comprising two circles for displaying a symbol (a colon in this example) separating the hour and minute is located between the hour segments 5A and the minute segments 5A.

As also shown in the same figure, a background segment 5C for displaying a background is also disposed to each of the segments 5A and 5B, and a background (a background of white or black) is displayed by these background segments 5C for each character (number or colon) displayed by the segments 5A and 5B. An electrophoretic display panel is used for the display panel 5 in this embodiment of the invention, and the construction of the display panel is further described in detail below. Segments 5A to 5C are referred to as segments 5X below when differentiating these segments 5A to 5C is not necessary.

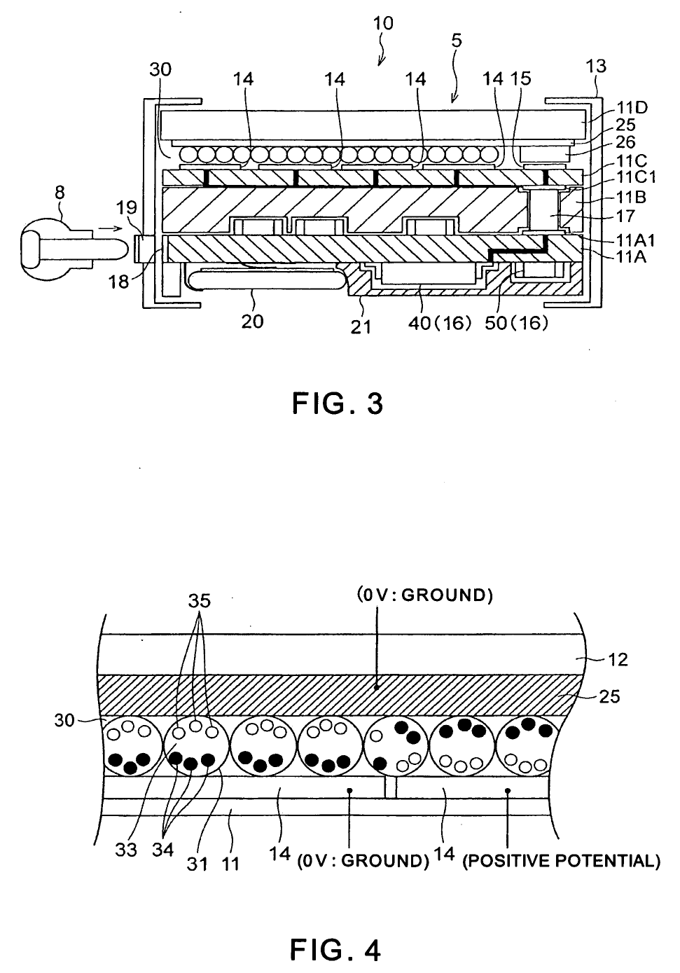

A time display unit 10 rendered in unison with the display panel 5 is disposed inside the watch case 2. As shown in the section view in FIG. 3, this time display unit 10 comprises a circuit board 11A, a display frame 11B, a display substrate 11C, a transparent substrate 11D, and a circuit retainer 13 for holding these other parts.

Segment electrodes 14 for each of the segments 5A to 5C, and a segment electrode 15 for a common electrode, are disposed on top of the display substrate 11C.

The circuit board 11A is on the bottom of the display substrate 11C with the display frame 11B therebetween, and devices 16 rendering the display drive circuit 40 and control unit 50, for example, are mounted on the circuit board 11A. A node 11A1 wired to device 16 (display drive circuit 40) is disposed on top of the circuit board 11A, a node 11C1 wired to the electrodes 14 and 15 is disposed on the bottom of the display substrate 11C, and these nodes 11A1 and 11C1 are electrically connected by a connector 17 passing through the display frame 11B.

A switch electrode 18 is disposed on the side of the circuit board 11A so that conductivity can be established by means of a flat spring 19 disposed to the circuit retainer 13. When the flat spring 19 is deformed as a result of depressing an operating button 8, conductivity is established through the flat spring 19 and the switch closes. Another device 16 (control unit 50 in this embodiment) detects whether the switch is closed or open.

A battery 20 (power supply) for supplying drive power to the devices 16 is removably installed on the bottom of the circuit board 11A. A circuit housing 21 covering the devices 16 is affixed to the circuit board 11A, and the devices 16 are thus protected by the circuit housing 21. A button battery, that is, a primary cell, is used for the battery 20 but the invention is not so limited and a secondary battery can be used instead.

A transparent common electrode 25 formed by ITO (indium tin oxide) vapor deposition, for example, is rendered on the display substrate 11C side of the transparent substrate 11D. An electrophoretic layer 30 is disposed between this transparent common electrode 25 and the segment electrodes 14 of the display substrate 11C, and a common electrode conductor 26 is disposed between the transparent common electrode 25 and the common segment electrode 15. This common electrode conductor 26 is made of a conductive rubber, for example, so that the conductive rubber is deformed according to the gap between the common electrode 25 and the common segment electrode 15 to assure a reliable connection between these electrodes 25 and 15.

As shown in FIG. 4, the electrophoretic layer 30 comprises a multitude of microcapsules 31. The microcapsules 31 are filled with an electrophoretic dispersion 33. Black electrophoretic particles (“black particles” below) 34 and white electrophoretic particles (“white particles” below) 35 are mixed in an electrophoretic dispersion 33, thus rendering a so-called two-particle electrophoretic layer. The black particles 34 and white particles 35 are oppositely charged, and in this embodiment of the invention the black particles 34 are positively charged and the white particles 35 are negatively charged.

When the display drive circuit 40 holds the common segment electrode 15 (FIG. 3) at 0 V (ground potential: potential L) and supplies a positive drive voltage causing a particular segment electrode 14 to go to a positive potential (potential H), a voltage difference is created between the segment electrode 14 to the common electrode 25. This voltage difference causes the positively charged black particles 34 inside the microcapsules 31 to move to the common electrode 25 side, and causes the negatively charged white particles 35 to move to the segment electrode 14 side.

conversely, when the common segment electrode 15 is held at a positive potential (potential H) by the display drive circuit 40 and the common electrode 25 goes H while a specific segment electrode 14 goes L, the negatively charged white particles 35 in the microcapsules 31 migrate to the common electrode 25 side and the positively charged black particles 34 migrate to the segment electrode 14 side.

Migration of black particles 34 and white particles 35 to the transparent substrate 11D side (the common electrode 25 side) where the particles can be seen can be adjusted, and the externally visible display color of the segment 5X can be changed between black and white, as a result of the display drive circuit 40 supplying drive signals to hold the common electrode 25 and segment electrodes 14 at a specific high or low potential.

When there is no potential difference between the common electrode 25 and segment electrode 14, the electrophoretic particles (black particles 34 and white particles 35) do not migrate, the display color of the segment 5X does not change, and the last display state is held.

In this embodiment of the invention the display drive circuit 40 has an internal booster circuit to boost the voltage (such as 3 V) supplied from the battery 20 to produce a +12 V voltage, and supplies this +12 V voltage or 0 V as the drive voltage to the segment electrodes 14 and common electrode 25.

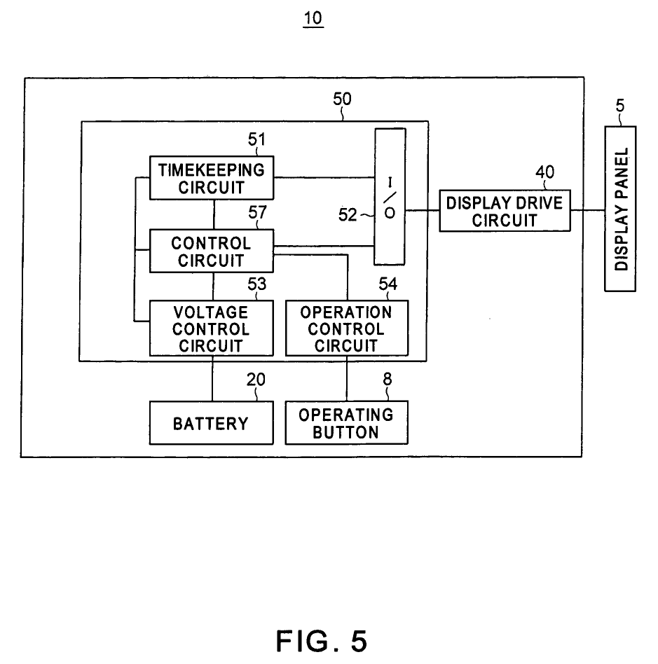

FIG. 5 shows the electrical arrangement of the time display unit 10.

A control unit 50 is electrically connected to the display drive circuit 40 and the battery 20 through an intervening wiring pattern rendered on the circuit board 11A, and comprises a timekeeping circuit 51, input/output (I/O) circuit 52, voltage control circuit 53, operation control circuit 54, and control circuit (control unit) 57.

The timekeeping circuit 51 functions as a timekeeping unit for keeping the time by counting oscillation pulses from an oscillation circuit not shown. The timekeeping circuit 51 is connected to the display drive circuit 40 through the I/O circuit 52.

The voltage control circuit 53 supplies power from the battery 20 to the internal parts of the control unit 50 and the display drive circuit 40. The operation control circuit 54 detects operation of the operating buttons 8 by detecting whether the switch electrode 18 is conductive or nonconductive, and reports the result to the control circuit 57.

The control circuit 57 centrally controls overall operation of the time display unit 10, and comprises a CPU, ROM, and RAM, for example. The CPU runs a control program stored in ROM to control operation of the parts of the control unit 50, and outputs commands to the display drive circuit 40 through the I/O circuit 52.

As described above, the display drive circuit 40 is a circuit for driving the display panel 5 and is controlled by the control circuit 57 to get the time information kept by the timekeeping circuit 51 and display the current time on the display panel 5 by supplying a drive signal to apply a drive voltage to the electrodes at a predetermined redraw interval to change the display color of each segment 5× of the display panel 5. The control circuit 57 and display drive circuit 40 function in this embodiment of the invention as a drive unit for supplying the drive signal to apply a drive voltage to the electrodes and change the display color of the display panel 5.

Drawing the display panel 5 is described next. In this embodiment of the invention the control circuit 57 manages the current drawing level (referred to below as the “current level”) for each segment 5× and sets the target drawing level (referred to below as the “target level”) for each segment 5X, compares the current level and target level, and controls the display writing process so that the current level becomes equal to the target level.

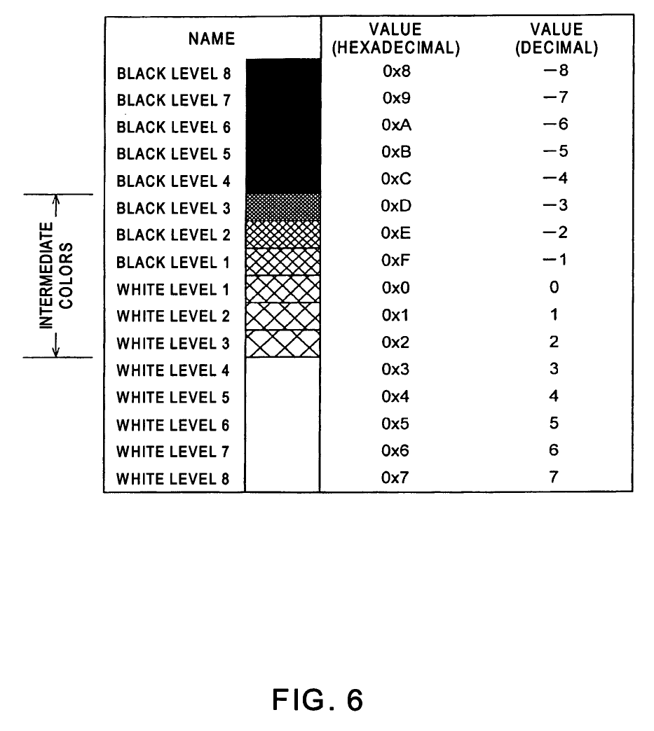

As shown in FIG. 6, there are sixteen drawing levels, including black levels 1 to 8 and white levels 1 to 8. The gradation range (equivalent to the range of reflectivity and contrast values) of the display panel 5 is black levels 1 to 4 and white levels 1 to 4, and levels exceeding this gradation range (black levels 5 to 8, and white levels 5 to 8) are set according to the retention time that the maximum gradation level (black level 4 and white level 4) is held when the maximum gradation level is held for a predetermined time or longer.

Black levels 1 to 3 and white levels 1 to 3 are intermediate colors between black and white (gray scale tones) To display a particular gray color, the drawing level of the desired gray color is set as the target level, and a drive signal (referred to below as “drive signal COM”) with a pulse count determined by the gray level is applied to redraw the display. To redraw the display from white level 4 to the intermediate color denoted black level 1, for example, the target level is set to black level 1, and a pulse signal is applied four times according to the drive method described further below. To redraw the display from white level 4 (white) to black level 4 (black), a pulse signal is applied seven times as described in detail below. By thus applying a drive signal with four pulses, which is less than the seven pulses required to go from white level 4 (white) to black level 4 (black), white particles 35 and black particles 34 migrate (move) a shorter distance inside the microcapsules 31, and this embodiment of the invention displays the desired gray level by controlling the relative positions of the white and black particles as desired.

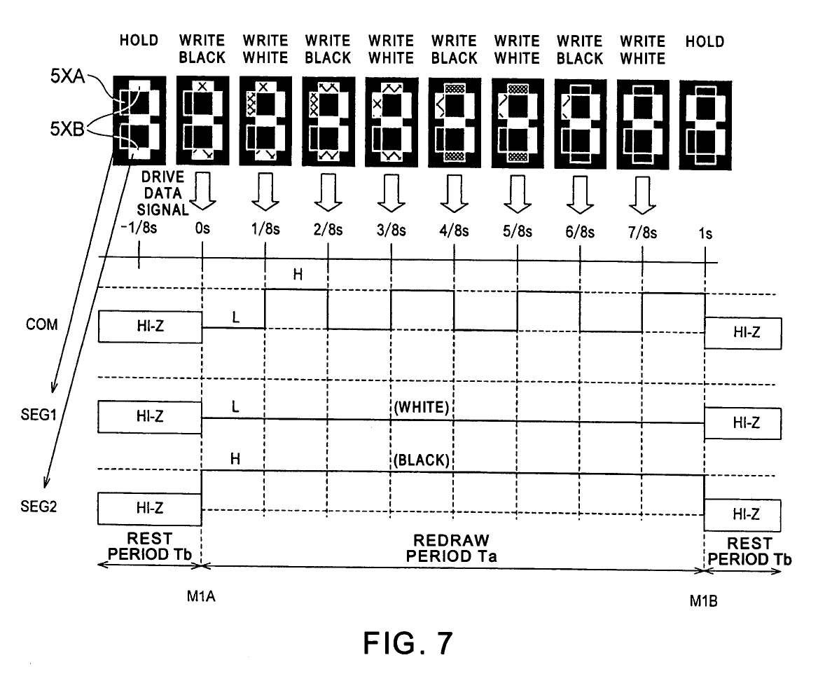

FIG. 7 is a waveform diagram of the drive signal applied to the display panel 5. This example shows changing the seven segments 5A from displaying the number “3” to displaying the number “4”. The drive signal (drive voltage) supplied to the common electrode 25 is denoted COM in FIG. 7, the drive signal (drive voltage) applied to the segment electrode 14 corresponding to the segment 5XA being switched from black to white is denoted SEG1, and the drive signal (drive voltage) applied to the segment electrode 14 corresponding to the segment 5XB being switched from white to black is denoted SEG2. Note that drive voltage SEG is used below when differentiating drive signal SEG1 and drive signal SEG2 is not necessary.

As shown in the figure, redraw period Ta is set to the period from the time M1A when the redraw display signal (driver data) is output from the control circuit 57 to the display drive circuit 40 to the time M1B when redrawing is completed, rest period Tb is the period not included in redraw period Ta. The redraw period Ta is the period in which the displayed time is changed by the display drive circuit 40 supplying drive signals (drive voltages) COM and SEG to the common electrode 25 and segment electrodes 14 to change the display color of the segments 5X. The rest period Tb is a standby period waiting for input of the next display switching signal after the display drive circuit 40 changes the time display, and the operating mode of the display drive circuit 40 is set to a power conservation mode during rest period Tb. The output nodes of the display drive circuit 40 for outputting drive voltages COM and SEG are set to a high impedance state during rest period Tb. A potential difference therefore does not occur between the common electrode 25 and segment electrodes 14 during rest period Tb, and the display color of the segments 5X remains the color that was set during redraw period Ta.

Changing the display color from white to black and changing the display color from black to white occur simultaneously during redraw period Ta in this embodiment of the invention. More specifically, the display drive circuit 40 applies a drive signal SEG of a voltage corresponding to the display color (white or black in this example) to be presented by a particular segment 5× to the segment electrode 14 of each segment 5X, and supplies a drive voltage COM of which the voltage changes over time according to the display color to the common electrode 25.

The drive signal COM in this embodiment of the invention is a pulse signal of which the voltage changes in pulses between a high potential (+12 V) and a low potential (0 V) according to the display switching signal (drive data). The pulse width W of one pulse of drive signal COM is set to a period (125 ms in this embodiment of the invention) that can be generated by frequency dividing a signal output from an oscillation circuit not shown, and the drive signal COM is generated based on this frequency division signal. The pulse count of the drive signal COM corresponds to the output count of the display switching signal, and the gray level of the display color of each segment 5X can be freely adjusted by appropriately setting this pulse count.

When the drive signal COM voltage is LOW in redraw period Ta, a field is created for the length of pulse width W between the common electrode 25 and the segment electrode 14 of the segment 5XB to which the HIGH potential drive signal SEG2 is applied, thus causing the black particles 34 in the microcapsules 31 to migrate toward the common electrode 25 and the white particles 35 to migrate toward the segment electrode 14, and changing the display color of the segment 5XB one gray level towards black. When the drive signal COM voltage then goes HIGH, a field is created for the length of pulse width W between the common electrode 25 and the segment electrode 14 of the segment 5XA to which the LOW potential drive signal SEG1 is applied, thus causing the white particles 35 in the microcapsules 31 to migrate toward the common electrode 25 and the black particles 34 to migrate toward the segment electrode 14, and changing the display color of the segment 5XB one gray level towards white.

The black particles 34 and white particles 35 thus migrate slightly between the common electrode 25 and segment electrode 14 in conjunction with the change in the drive signal COM voltage over time, thereby incrementally changing the display color of each segment 5XA and segment 5XB so that over the course of redraw period Ta the display color of segment 5XA changes to white, the display color of segment 5XB change to black, and the seven segments 5A change from displaying the number “3” to displaying the number “4.”

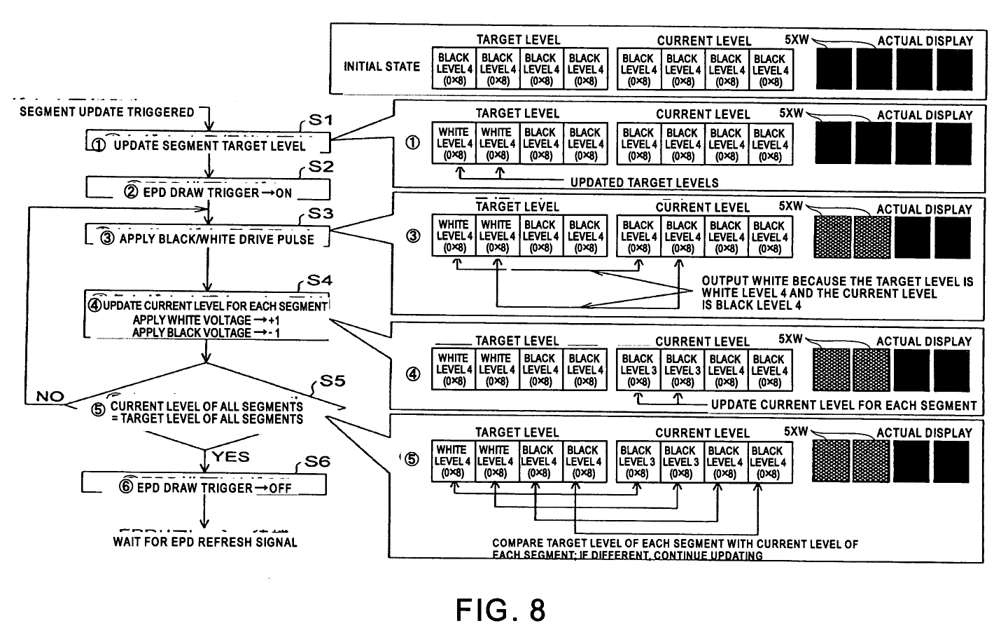

The drawing process is described next below. FIG. 8 is a flow chart showing the basic operation of this drawing process. This drawing process is executed when updating the segment 5X is triggered to update the time (the time is updated at a one minute interval in this embodiment of the invention) or when a particular operating button 8 is pressed to update the display (such as to change the background pattern). In the example shown in FIG. 8 the current level of four segments 5X is black level 4 and two of these segments 5XW are changed to display white level 4. The target level of all four segments when this process starts is set to black level 4 (the same level as the current level).

To redraw a segment the control circuit 57 first updates the target level of the segments 5XW to be updated to the target white level 4 (step S1), and sets the EPD draw trigger to ON (step S2). When the EPD draw trigger goes ON, the control circuit 57 starts outputting the display switching signal (drive data) to the display drive circuit 40. More specifically, the control circuit 57 compares the current level and the target level of all segments 5X to find the segments 5X (5XW) for which the current level and the target level differ, determines whether to change those segments 5X to white or black, and based on the result of this determination outputs a display switching signal for changing the display to white or black (a signal instructing changing the display to white in this example) to the display drive circuit 40 (step S3).

When a display switching signal is input, the display drive circuit 40 therefore outputs a drive signal SEG setting the segment electrode 14 of segments 5XW to the LOW potential corresponding to white, outputs drive signal COM setting the common electrode 25 to a HIGH potential for a predetermined period (125 ms), and thus causes the display color of segments 5XW to change one gray level from black level 4 to black level 3.

The control circuit 57 then updates the current level of segments 5XW from black level 4 to black level 3 (step S4), determines if the current level of all updated segments 5X matches the target level of each segment (step S5), and if the current level does not match the target level (step S5 returns No), returns to step S3.

In order to gradually shift the display color of each segment 5XW where the current level and target level do not match toward the target level, the control circuit 57 continues to intermittently output a display switching signal to the display drive circuit 40 and update the current level one level each time the display switching signal is output until the current level of all segments 5X match the target level. As a result, a drive signal COM of which the voltage level switches a number of times equal to the difference between the current level and target level is supplied to the common electrode 25 as shown in FIG. 7, and the display color of the segments 5XW of which the segment electrode 14 is held LOW corresponding to a display color of white are changed to a display color denoted white level 4 equal to the target level.

When the current level and target level of all segments 5X match (step S5 returns Yes), the control circuit 57 turns the EPD draw trigger OFF. This completes the basic display writing process. This writing process thus supplies a drive signal COM with a pulse count corresponding to the difference between the target level and the current level, and the display color of segments 5X held at the potential level corresponding to white or black by drive signal SEG changes to the display color of the target level.

When a segment 5X displays black or white instead of an intermediate display color, this embodiment of the invention also applies a display refresh process at a predetermined interval to update the level of the display color of those segments 5X, and executes a current level updating process to update the value of the current level according to how long each segment 5X has displayed black or white continuously.

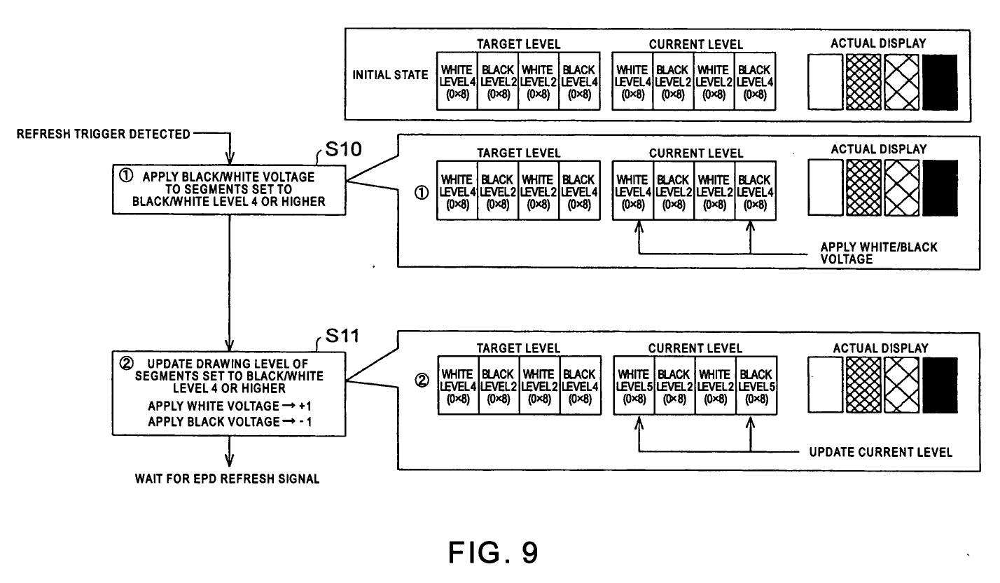

Referring to FIG. 9, when the predetermined refresh time (refresh period) comes, the control circuit 57 gets the current level of all segments 5X, applies a drawing process to write black to the segments 5X of which the current level is set to black level 4 or greater (black level 4 to 8), and applies a drawing process to write white to the segments 5X of which the current level is set to white level 4 or greater (white level 4 to 8) (display refresh process (step S10)). The control circuit 57 therefore outputs a display switching signal for displaying black and applies the same process to the segments 5X that are set to black level 4 or higher as the process (write black) whereby the display drive circuit 40 changes the display color one gradation level, and outputs a display switching signal for displaying white and applies the same process to the segments 5X that are set to white level 4 or higher as the process (write white) whereby the display drive circuit 40 changes the display color one gradation level.

Segments 5X displaying black level 4 or higher or white level 4 or higher, that is, segments 5X displaying a color at the maximum black level or the maximum white level that can be presented on the display panel 5, are thus prevented from shifting over time to an intermediate gray level and displaying an intermediate color, and shifting of the display level (reflectivity and contrast) can be eliminated.

After the display refresh process, the control circuit 57 increments by one the value of the current level of each segment 5X for which the current level is black level 4 or higher (black level 4 to 8) or white level 4 or higher (white level 4 to 8) (step S11). More specifically, the control circuit 57 increments black level 4 to black level 5 and so forth until black level 7 goes to black level 8, and increments white level 4 to white level 5 and so forth until white level 7 goes to white level 8. If the black level or white level is already set to the highest level (see FIG. 6), that is, black level 8 and white level 8, the current level is maintained. The current level is increased one level each time the display refresh process executes in this example, but the invention is not so limited and the current level could be increased one level each time the display refresh process executes a plural number of times (such as every 10 times).

This embodiment of the invention updates the current level of black and white segments 5X where the display color is not an intermediate gray level so that the current level increases in proportion to how long the display color has been continuously displayed. As a result, when the display color of one of these segments 5X is then changed, the difference between the target level and the current level increases proportionally to the time the display color was continuously displayed before the color is changed, and the pulse count of the drive signal COM supplied to change the display color (during the drawing process) therefore increases.

As the continuous display time of a particular display color increases, this embodiment of the invention thus increases the pulse count of the drive signal COM that is supplied when changing the display color.

This embodiment of the invention drives an electrophoretic display panel 5 having electrophoretic characteristics whereby movement of electrophoretic particles becomes slower as the time in which there is no change in the display state increases by increasing the pulse count of the drive signal COM that is supplied to change the display color to the same target level as the continuous display time of the current display color increases. The drive power (drive voltage*voltage apply time) of the display panel 5 can therefore be changed according to the change in the electrophoretic characteristics, thereby compensating for change in the electrophoretic characteristics and reliably changing the display color to black or white. It is therefore possible to prevent displaying inconsistent colors due to differences in electrophoretic characteristics that vary when the display is redrawn according to how long the display color has been continuously displayed, and display quality (design, appearance, readability) can be improved.

Furthermore, this embodiment of the invention incrementally increases the drive power (the pulse count of the drive signal COM) according to the continuous display time of the display color, and can therefore also reduce power consumption because more drive power than necessary is not applied.

### Second Embodiment

A wristwatch 1 according to a second embodiment of the invention is identical to the wristwatch 1 according to the first embodiment except that the pulse count of the drive signal COM when changing the display color is changed according to the size of the display area in which the display color is being changed. Like parts in this and the first embodiment are identified by like reference numerals, and further description thereof is omitted below.

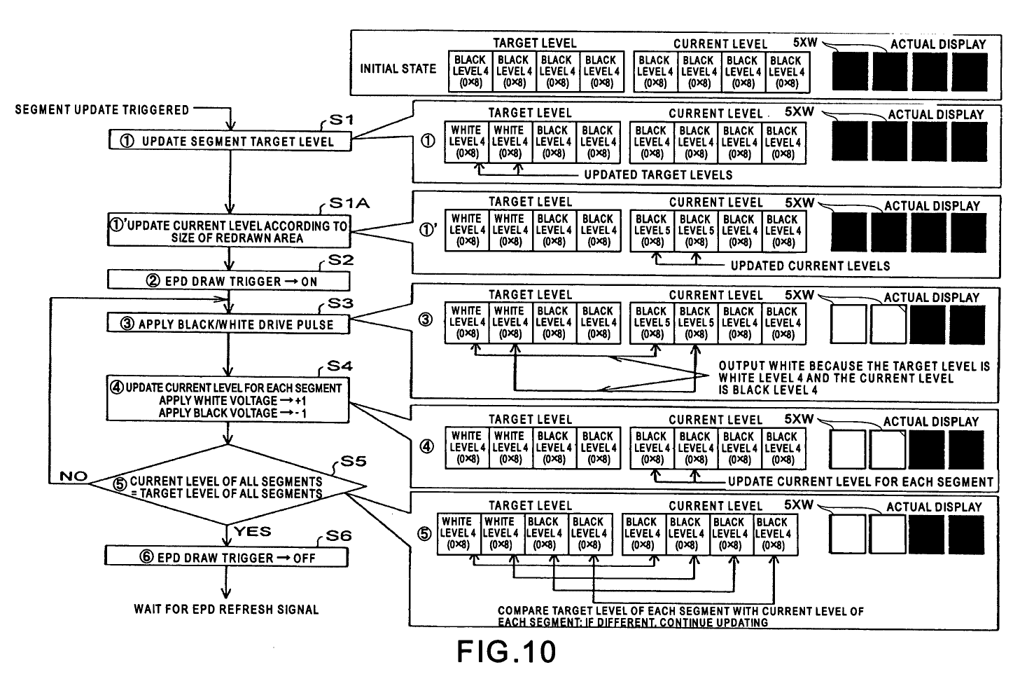

FIG. 10 is a flow chart of a drawing process according to this second embodiment of the invention. In the example shown in FIG. 8 the current level of four segments 5X is black level 4 and two of these segments 5XW are changed to display white level 4. The target level of all four segments when this process starts is set to black level 4 (the same level as the current level).

When a segment update is triggered, the control circuit 57 updates the target level of the segments 5XW to be updated to the target white level 4 (step S1), and then executes a current level update process (step S1A) that compares the target level and current level, calculates the display area to be changed for each color, and updates the current level of the segments 5X to be redrawn according to the size of the area to be redrawn for each color. In this embodiment of the invention the area of each segment 5X is assumed to be substantially the same, and the area to be redrawn for each color is determined from the number of segments 5XW to be changed to a different color.

More specifically, if the number of segments 5XW being changed from black to white is 2 to k1 (where k1 is an integer of 2 or more), the current level of those segments 5XW is increased 1 (from black level 4 to black level 5); if the number of segments 5XW being changed is (k1+1) to m1 (where m1 is an integer of (k1+1) or more), the current level of those segments 5XW is increased 2 (from black level 4 to black level 6); and if the number of segments 5XW being changed is (m1+1) to n1 (where n1 is an integer of (m1+1) or more), the current level of those segments 5XW is increased 3 (from black level 4 to black level 7). The value of the current black level is thus updated to a higher value according to the size of the area being switched from black to white.

Likewise, if the number of segments 5XW being changed from white to black is 2 to k2 (where k2 is an integer of 2 or more), the current level of those segments 5XW is increased 1 (from white level 4 to white level 5); if the number of segments 5XW being changed is (k2+1) to m2 (where m2 is an integer of (k2+1) or more), the current level of those segments 5XW is increased 2 (from white level 4 to white level 6); and if the number of segments 5XW being changed is (m2+1) to n2 (where n2 is an integer of (m2+1) or more), the current level of those segments 5XW is increased 3 (from white level 4 to white level 7). The value of the current white level is thus updated to a higher value according to the size of the area being switched from white to black.

Next, as in the first embodiment, the control circuit 57 sets the EPD draw trigger to ON (step S2). The display drive circuit 40 then supplies a drive signal SEG driving the segment electrodes 14 of the segments 5XW being changed to white to the LOW potential corresponding to white, supplies a drive signal COM of a pulse count corresponding to the difference between the target level and current level to the common electrode 25, and changes the display color from black to white (steps S2 to S6).

This embodiment of the invention thus sets the current level of the segments 5X being changed from displaying black to white or from white to black to a higher value proportionally to the display area of the segments 5X of each color. As a result, the pulse count of the drive signal COM that drives the redrawing process can be increased as the display area of each display color increases.

In an electrophoretic display panel 5 having electrophoretic characteristics whereby changing the display color becomes more difficult as the area to be changed increases, this embodiment of the invention drives the display panel 5 by increasing the pulse count of the drive signal COM that is supplied to change the display color to the same target level as the size of the display area to be changed increases. The drive power (drive voltage*voltage apply time) of the display panel 5 can therefore be changed according to the change in the electrophoretic characteristics, thereby compensating for change in the electrophoretic characteristics and reliably changing the display color over a wide area to black or white. It is therefore possible to prevent displaying inconsistent colors due to differences in electrophoretic characteristics that vary when the display is redrawn according to the size of the display area in which the display color is changed, and display quality (design, appearance, readability) can be improved.

Furthermore, this embodiment of the invention incrementally increases the drive power (the pulse count of the drive signal COM) according to the continuous display time of the display color, and can therefore also reduce power consumption because more drive power than necessary is not applied.

The preceding embodiments describe the present invention by way of example only, and can be varied in many ways without departing from the scope of the invention. For example, the pulse count of the drive signal COM is adjusted according to how long the display color was continuously displayed before being changed to a different display color, or the pulse count of the drive signal COM is adjusted according to the area of the display color being changed, but the invention is not limited to these methods. More particularly, the pulse count (drive pulse count) of the drive signal COM can be adjusted based on both the continuous display time and the display area of the display color being changed.

Furthermore, the drive pulse count is increased according to the electrophoretic characteristics of the display panel 5 in the preceding embodiments by way of example only. What is important is that the drive power of the display panel 5 is changed according to the electrophoretic characteristics of the display panel 5 when the display is redrawn. In addition to methods of changing the drive pulse count, methods of changing the drive power of the display panel 5 include methods of changing the drive voltage apply time of each pulse of the drive signal COM, and methods of changing the drive voltage.

By thus increasing the drive voltage apply time or increasing the drive voltage as the continuous display time of the display color being changed increases or the display area of the display color increases, displaying inconsistent colors as a result of differences in the electrophoretic characteristics when the display is redrawn can be avoided, and display quality can therefore be improved.

The present invention can therefore be achieved by an arrangement that changes at least one of the drive pulse count, the drive voltage apply time, and the drive voltage according to either or both the continuous display time of the display color before the display color is changed and the display area of the display color being changed. When drawing an intermediate color, the invention is not limited to setting the drive pulse count to achieve the intermediate color of the intended gray level, and a method of setting the drive voltage apply time of each pulse in the drive signal COM, or a method of setting the drive voltage, can be used as desired.

A segment-type electrophoretic display panel 5 is used by way of example in these embodiments of the invention, but the invention is not so limited and can also be applied to a dot matrix display. More particularly, the invention changes the drive pulse count, the drive voltage apply time, or the drive voltage based on the continuous display time or the size of the display area of the display color based on a specific display unit (such as segments or dots).

When the area of the display units differ, the area of each display unit (each segment using a segment display for example) is stored in memory, the area of the display color being switched (both the area switched from white to black and the area switched from black to white in this example) is calculated based on these display unit areas, and at least one of the drive pulse count, drive voltage apply time, and drive voltage is changed according to the size of the display area being switched. By thus calculating the area of the display color being redrawn and then driving the display based on the calculated area, displaying inconsistent colors can be avoided and power consumption can be further reduced.

This embodiment of the invention is described using a wristwatch by way of example, but the invention is not so limited and can be applied to a wide range of electronic devices (display devices) that use an electrophoretic display panel. For example, the invention can be used in a mantle clock, a wall clock, a grandfather clock, a pocket watch, or other type of timepiece, personal digital assistants (PDA), cell phones, printers, scanners, and notebook computers. When rendered as a portable device such as a timepiece, the invention is also not limited to wristwatches, and can be adapted to various other shapes, including necklaces, rings, and pendants. The invention can also be widely used in drive devices that are disposed internally to or externally connected to an electronic device (display device) for driving an electrophoretic display panel.

The entire disclosure of Japanese Patent Application No. 2005-267543, filed Sep. 14, 2005 is expressly incorporated by reference herein.

The entire disclosure of Japanese Patent Application No. 2005-267543, filed Sep. 14, 2005 is expressly incorporated by reference herein.

What is claimed is:

1. A display device comprising:
an electrophoretic display panel comprising two types of electrophoretic particles of different color and polarity between electrodes;
a drive unit for supplying a drive signal to apply a drive voltage between the electrodes and switching a display color of the electrophoretic display panel between the colors of the electrophoretic particles;
wherein the drive unit supplies a drive signal of which the drive power is changed according to the electrophoretic characteristics when the display color of the electrophoretic display panel is changed in order to change the display color of the electrophoretic display panel.

2. The display device described in claim 1, wherein:
the drive unit supplies a drive signal of which the drive power is changed according to the continuous display time of the display color before the display color changes when the display color of the electrophoretic display panel is changed.

3. The display device described in claim 2, wherein:
the drive unit supplies a drive signal in which the number of drive pulses for applying the drive voltage is changed according to the continuous display time of the display color before the display color changes.

4. The display device described in claim 2, wherein:
the drive unit supplies a drive signal in which the drive voltage apply time is changed according to the continuous display time of the display color before the display color changes.

5. The display device described in claim 2, wherein:
the drive unit supplies a drive signal in which the drive voltage is changed according to the continuous display time of the display color before the display color changes.

6. The display device described in claim 1, wherein:
the drive unit supplies a drive signal of which the drive power is changed according to the area of the display color being changed when the display color of the electrophoretic display panel is changed.

7. The display device described in claim 6, wherein:
the drive unit supplies a drive signal in which the number of drive pulses for applying the drive voltage is changed according to the area of the display color being changed when the display color of the electrophoretic display panel is changed.

8. The display device described in claim 6, wherein:
the drive unit supplies a drive signal in which the drive voltage apply time is changed according to the area of the display color being changed when the display color of the electrophoretic display panel is changed.

9. The display device described in claim 6, wherein:
the drive unit supplies a drive signal in which the drive voltage is changed according to the area of the display color being changed when the display color of the electrophoretic display panel is changed.

10. A drive device comprising:
a drive unit for supplying a drive signal to apply a drive voltage between electrodes of an electrophoretic display panel comprising two types of electrophoretic particles of different color and polarity between the electrodes;
wherein the drive unit supplies a drive signal of which the drive power is changed according to the electrophoretic characteristics when the display color of the electrophoretic display panel is changed in order to change the display color of the electrophoretic display panel.

11. The drive device described in claim 10, wherein:
the drive unit supplies a drive signal of which the drive power is changed according to the continuous display time of the display color before the display color changes when the display color of the electrophoretic display panel is changed.

12. The drive device described in claim 11, wherein:
the drive unit supplies a drive signal in which the number of drive pulses for applying the drive voltage is changed according to the continuous display time of the display color before the display color changes.

13. The drive device described in claim 11, wherein:
the drive unit supplies a drive signal in which the drive voltage apply time is changed according to the continuous display time of the display color before the display color changes.

14. The drive device described in claim 11, wherein:
the drive unit supplies a drive signal in which the drive voltage is changed according to the continuous display time of the display color before the display color changes.

15. The drive device described in claim 10, wherein:
the drive unit supplies a drive signal of which the drive power is changed according to the area of the display color being changed when the display color of the electrophoretic display panel is changed.

16. The drive device described in claim 15, wherein:
the drive unit supplies a drive signal in which the number of drive pulses for applying the drive voltage is changed according to the area of the display color being changed when the display color of the electrophoretic display panel is changed.

17. The drive device described in claim 15, wherein:
the drive unit supplies a drive signal in which the drive voltage apply time is changed according to the area of the display color being changed when the display color of the electrophoretic display panel is changed.

18. The drive device described in claim 15, wherein:
the drive unit supplies a drive signal in which the drive voltage is changed according to the area of the display color being changed when the display color of the electrophoretic display panel is changed.

19. A drive method for supplying a drive signal to apply a drive voltage between electrodes of an electrophoretic display panel comprising two types of electrophoretic particles of different color and polarity between the electrodes to change a display color of the electrophoretic display panel between the colors of the electrophoretic particles, wherein:
a drive signal of which the drive power is changed according to the electrophoretic characteristics when the display color of the electrophoretic display panel is changed is supplied when changing the display color of the electrophoretic display panel in order to change the display color of the electrophoretic display panel.

20. The drive method described in claim 19, wherein:
a drive signal of which the drive power is changed according to the continuous display time of the display color before the display color changes is supplied when changing the display color of the electrophoretic display panel.
